(19) United States
(12) Patent Application Publication
(10) Pub. No.: US 2021/0262638 A1
(43) Pub. Date: Aug. 26, 2021

(54) FLOATING SOLAR POWERED LIGHT DISPLAY WITH REPLACEABLE DISPLAY FILMS

(71) Applicant: Westbay LLC, Gilbert, AZ (US)

(72) Inventors: Jun Zhao, Shanghai (CN); Jianwen Bao, Shanghai (CN); Chuanxiang Zhang, Shanghai (CN)

(21) Appl. No.: 17/185,716

(22) Filed: Feb. 25, 2021

Related U.S. Application Data
(60) Provisional application No. 62/982,016, filed on Feb. 26, 2020.

(51) Int. Cl. F21V 9/00; F21V 23/04; F21V 23/06; F21V 31/00; F21S 9/03

(52) U.S. Cl. CPC F21V 9/00; F21V 23/0435; F21Y 2115/10; F21V 31/005; F21S 9/037; F21V 23/06

(57) ABSTRACT

A floating light display with a top cover, a bottom cover, and a plurality of display films. The top cover has a top surface and a bottom surface opposite the top surface. At least one top light may be visible at the top surface and at least on bottom light is visible at the bottom surface. A remote control sensor and at least one control button may be disposed on the top surface and configured to control selection of at least one of a light illumination pattern and a light illumination color for the top light and the bottom light. The bottom cover encloses the bottom light and one of the plurality of display films within the floating light display. When the bottom light is illuminated, the selected display film filters the light emitted by the bottom light to project an image on an opposing surface within the pool.

### CROSS REFERENCE TO RELATED APPLICATIONS

This application claims the benefit of the filing date of U.S. Provisional Patent Application 62/982,016 entitled “FLOATING SOLAR POWERED LIGHT DISPLAY WITH RECPLACEABLE MESSAGE FILMS” to Zhao, et. al., that was filed on Feb. 26, 2020, the disclosure of which is hereby incorporated herein by this reference.

### TECHNICAL FIELD

Aspects of this document relate generally to floating light displays for pools of water, and more specifically to floating light displays with replaceable display films.

### BACKGROUND

A body or pool of water is commonly included in the landscaping or décor of venues or backyards. Event hosts often include the body of water in decorating for events. Thus, there is a need for additional methods for decorating the body of water.

### SUMMARY

Aspects of this document relate to a floating light display for a pool, the floating light display comprising a top cover having a top surface and a bottom surface opposite the top surface, at least one top LED light visible at the top surface and at least one bottom LED light visible at the bottom surface, a remote control sensor and at least one control button each disposed on the top surface and configured to control selection of at least one of a light illumination pattern and a light illumination color for the at least one top LED light and the at least one bottom LED light based on input from a user, wherein the remote control sensor is configured to receive the input from the user through a remote control, a power charging port disposed on the top surface, covered by a water-resistant flap, and configured to charge the floating light display when electrically coupled to a power source, a bottom cover formed of a transparent material and configured to couple with the top cover and enclose the at least one bottom LED light between the bottom cover and the top cover, a seal configured to extend around a perimeter of the top cover and, when the bottom cover is coupled with the top cover, reduce fluid flow through an interface between the top cover and the bottom cover, and a plurality of display films, including a selected display film, each having a thickness less than 1.6 millimeters and each molded to a shape complimentary to an inner surface of the bottom cover and configured to be separately inserted into and seated within the bottom cover, the display films each having a different image displayed on a respective display film, the image including a subject and a background, wherein one of the subject and the background is transparent and the other one of the subject and the background is shaded, wherein, when the at least one bottom LED light is illuminated, the selected display film seated within the bottom cover filters the light emitted by the bottom light to project the image on an opposing surface within the pool.

Particular embodiments may comprise one or more of the following features. The floating light display may further comprise a solar panel disposed on the top surface and configured to charge the floating light display when the solar panel is exposed to the sun. The plurality of display films may each have a thickness of between 0.3 millimeters and 0.5 millimeters. The at least one top LED light may be an outer light ring.

Aspects of this document relate to a floating light display for a body of water, the floating light display comprising a top cover having a top surface and a bottom surface opposite the top surface, at least one top light visible at the top surface and at least one bottom light visible at the bottom surface, at least one control button disposed on the top surface and configured to control selection of at least one of a light illumination pattern and a light illumination color for the at least one top light and the at least one bottom light based on input from a user, a charging port disposed on the top surface and configured to charge the floating light display when electrically coupled to a power source, a bottom cover formed of a transparent material and configured to couple with the top cover and enclose the at least one bottom light between the bottom cover and the top cover, and a plurality of display films, including a selected display film, each molded to a shape complimentary to an inner surface of the bottom cover and configured to sit within the bottom cover, the display films each having a different image displayed on a respective display film, wherein, when the bottom light is illuminated, the selected display film seated within the bottom cover filters the light emitted by the bottom light to project the image on an opposing surface within the body of water.

Particular embodiments may comprise one or more of the following features. The floating light display may further comprise a remote control sensor disposed on the top surface and configured to control selection of at least one of the light illumination pattern and the light illumination color for the at least one top light and the at least one bottom light based on the input from the user, wherein the remote control sensor is configured to receive the input from the user through a remote control. The image may include a subject and a background, wherein one of the subject and the background is transparent and the other one of the subject and the background is shaded. The floating light display may further comprise a seal configured to extend around a perimeter of the top cover and, when the bottom cover is coupled with the top cover, reduce fluid flow through an interface between the top cover and the bottom cover. The floating light display may further comprise a solar panel disposed on the top surface and configured to charge the floating light display when the solar panel is exposed to the sun. The plurality of display films may each have a thickness of between 0.3 millimeters and 0.5 millimeters. The at least one top light may be an outer light ring.

Aspects of this document relate to floating light display for a body of water, comprising a top cover having a top surface and a bottom surface opposite the top surface, at least one bottom light visible at the bottom surface, a bottom cover formed of a transparent material and configured to couple with the top cover and enclose the at least one bottom light between the bottom cover and the top cover, and a display film shaped complimentary to an inner surface of the bottom cover and configured to sit within the bottom cover, wherein, when the bottom light is illuminated, the display film filters the light emitted by the bottom light to project an image on an opposing surface within the body of water.

Particular embodiments may comprise one or more of the following features. The floating light display may further comprise at least one top light disposed on the top cover. The floating light display may further comprise at least one control button disposed on the top surface and configured to control selection of at least one of a light illumination pattern and a light illumination color for the at least one bottom light based on input from a user. The floating light display may further comprise a remote control sensor disposed on the top surface and configured to control selection of at least one of a light illumination pattern and a light illumination color for the at least one bottom light based on input from a user, wherein the remote control sensor is configured to receive the input from the user through a remote control. The floating light display may further comprise a charging port disposed on the top surface and configured to charge the floating light when electrically coupled to a power source. The floating light display may further comprise a solar panel disposed on the top surface and configured to charge the floating light display when the solar panel is exposed to the sun. The floating light display may further comprise a seal configured to extend around a perimeter of the top cover and, when the bottom cover is coupled with the top cover, reduce fluid flow through an interface between the top cover and the bottom cover. The display film may have a thickness of less than 1.6 millimeters. The display film may have a thickness of between 0.3 millimeters and 0.5 millimeters.

The foregoing and other aspects, features, applications, and advantages will be apparent to those of ordinary skill in the art from the specification, drawings, and the claims. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those of ordinary skill in the art from the specification, drawings, and the claims.

### BRIEF DESCRIPTION OF THE DRAWINGS

Implementations will hereinafter be described in conjunction with the appended drawings, where like designations denote like elements, and:

FIG. 1 is a perspective view of a floating light display for a pool of water.

FIG. 2 is an exploded view of the floating light display shown in FIG. 1.

FIG. 3 is a top view of the floating light display shown in FIG. 1.

FIG. 4 is a side view of the floating light display shown in FIG. 1.

FIG. 5 is a bottom view of the top cover of the floating light display shown in FIG. 1.

FIG. 6 is a perspective view of a display film configured to seat within the floating light display shown in FIG. 1.

FIG. 7 is a 2D view of potential images of the plurality of display films.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of implementations that are described in many different forms, there is shown in the drawings and will herein be described in detail particular implementations with the understanding that the present disclosure is to be considered as an exemplification of the principles of the disclosed methods and systems, and is not intended to limit the broad aspect of the disclosed concepts to the implementations illustrated.

In the following description, reference is made to the accompanying drawings which form a part hereof, and which show by way of illustration possible implementations. It is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure. As will become apparent, changes may be made in the function and/or arrangement of any of the elements described in the disclosed exemplary implementations without departing from the spirit and scope of this disclosure.

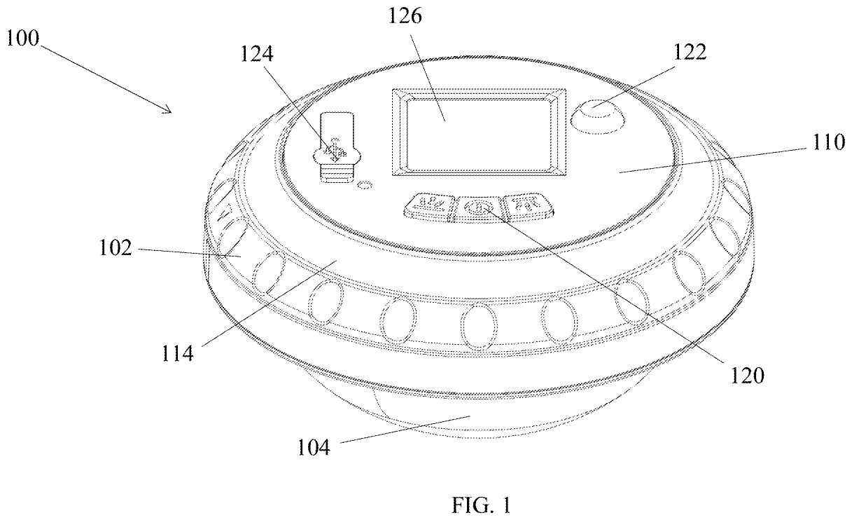

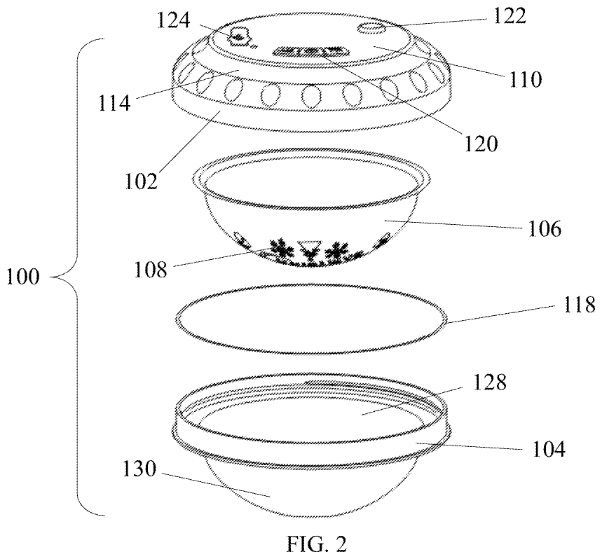

The present disclosure relates to a floating light display 100 configured to float in a pool or body of water and provide decorative lighting. As shown in FIGS. 1-2, the floating light display 100 comprises a top cover 102, a bottom cover 104, and a plurality of interchangeable display films 106 (only one is shown in FIG. 2). The floating light display 100 is configured to allow a user to change out the image 108 being displayed by the floating light display 100 by switching which display film 106 is seated within the floating light display 100.

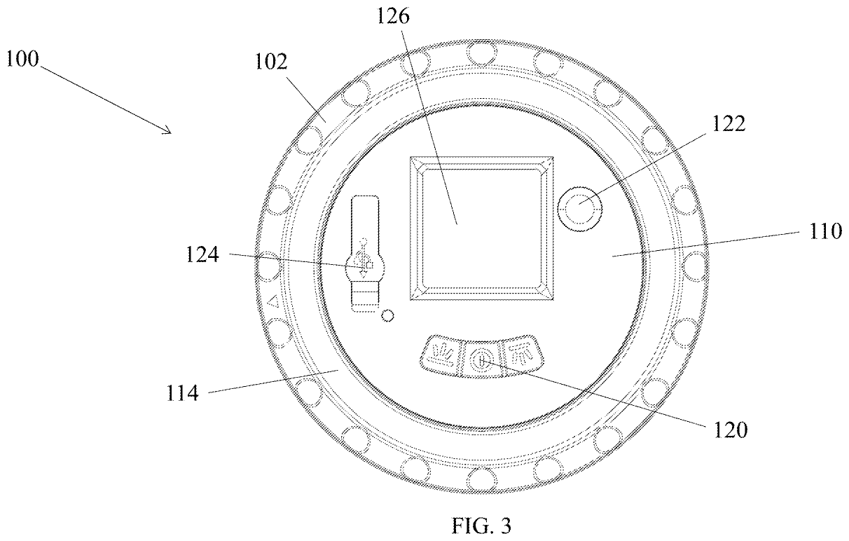

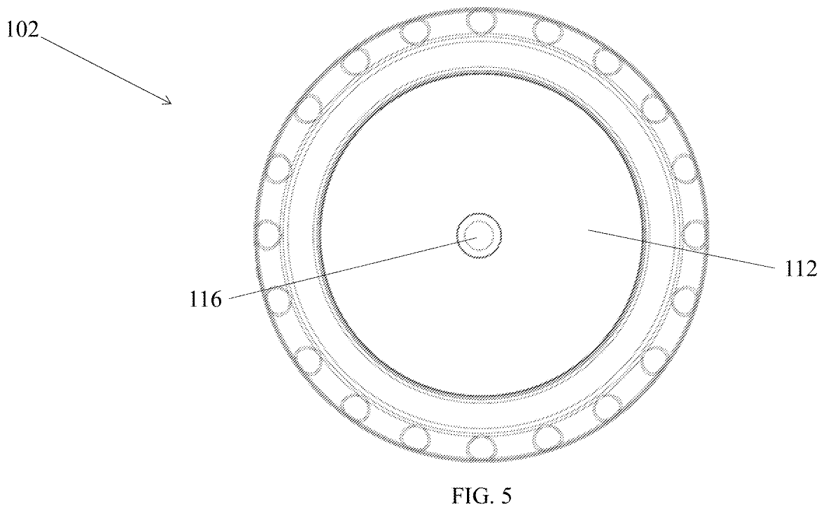

The top cover 102 has a top surface 110 and a bottom surface 112 (see FIG. 5). The bottom surface 112 is opposite the top surface 110. At least one top light 114 may be visible at the top surface 110. The at least one top light 114 may be an outer light ring, as shown in FIG. 3. The at least one top light 114 may also be a bulb, and may be arranged in a different shape, such as a star, a flower, or any other decorative shape. At least one bottom light 116 is visible at the bottom surface 112 (see FIG. 5). The top light 114 and the bottom light 116 may be any light designed to provide illumination. In some embodiments, the top light 114 and the bottom light 116 are each light emitting diode (LED) lights. The LEDs used may include any LEDs known, and include, without limitation, RGB atmosphere LEDs and high-performance monochromatic LEDs. In a particular embodiment, the top light 114 has three RGB atmosphere LEDs and the bottom light 116 has four high-performance monochromatic LEDs.

The bottom cover 104 is configured to couple with the top cover 102, as shown in FIG. 2. The floating light display 100 may further comprise a seal 118 configured to extend around a perimeter of the top cover 102. When the bottom cover 104 is coupled to the top cover 102, the bottom light 116 may be enclosed between the bottom cover 104 and the top cover 102, and the seal 118 may reduce fluid flow through an interface between the top cover 102 and the bottom cover 104.

Turning to FIG. 3, the top surface 110 may have a number of features disposed thereon. For example, at least one control button 120 may be disposed on the top surface 110. The at least one control button 120 may be configured to control selection of at least one of a light illumination pattern and a light illumination color for the top light 114 and the bottom light 116 based on input from a user. For example, the at least one control button 120 may be used to cycle through various light display modes that may include a selection of colors, flashing patterns, illumination intensities, pre-programmed patterns of colors, flashing patterns, and intensities, and other lighting effects as programmed into a processor associated with the lights, the buttons, and the unit as a whole. There may be separate control buttons 120 for the top light 114 and the bottom light 116, respectively. In addition, there may be separate control buttons 120 to control the color, flashing pattern, and intensity of the top light 114 and of the bottom light 116. The at least one control button 120 may also be disposed on the bottom surface 112 of the top cover 102. The top surface 110 may also have a remote control sensor 122 disposed thereon configured to receive the input from the user through a remote control. The remote control sensor 122 may be configured to communicate with the remote control through infrared signals. Additionally, or alternatively, the remote control sensor 122 may be configured to communicate with the remote control through Bluetooth, Wi-Fi, or some other wireless connection, as known in the art. The remote control may be a separate unit, or may integrated into another device. For example, the remote control may be an app on a mobile device. In such an embodiment, the floating light display 100 is configured to receive the input from the mobile device. As with the at least one control button 120, the remote control sensor 122 is configured to control selection of at least one of the light illumination pattern and the light illumination color for the top light 114 and the bottom light 116. The remote control sensor 122 may also be disposed on the bottom surface 112 of the top cover 102, or may be embedded within the top cover 102.

The floating light display 100 may be powered by a rechargeable battery. The battery may be a lithium-ion battery, and may have a rating such as a 2000 mAh rating. In such an embodiment, the battery may have over 6 hours of runtime on a charge. The battery may be charged through a power charging port 124 disposed on the top cover 102. In some embodiments, the power charging port 124 is disposed on the top surface 110 of the top cover 102. The power charging port 124 may also be disposed on the bottom surface 112 of the top cover 102, or at some other location on the top cover 102. The power charging port 124 is configured to charge the floating light display 100 when the power charging port 124 is electrically coupled to a power source. The power charging port 124 may be covered by a water-resistant flap to help limit the entrance of water and other contaminants into the power charging port 124. The battery may also be charged by a solar panel 126 disposed on the top surface 110, instead of or in addition to the power charging port 124. The solar panel 126 is configured to charge the floating light display 100 when the solar panel 126 is exposed to the sun.

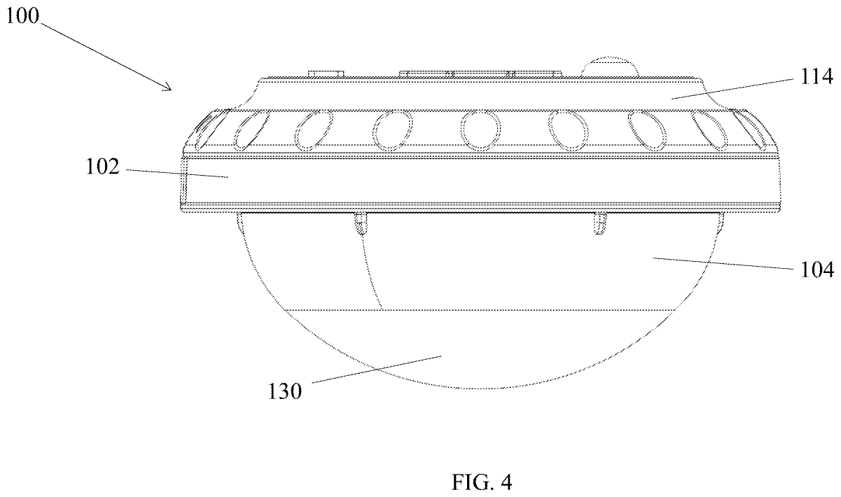

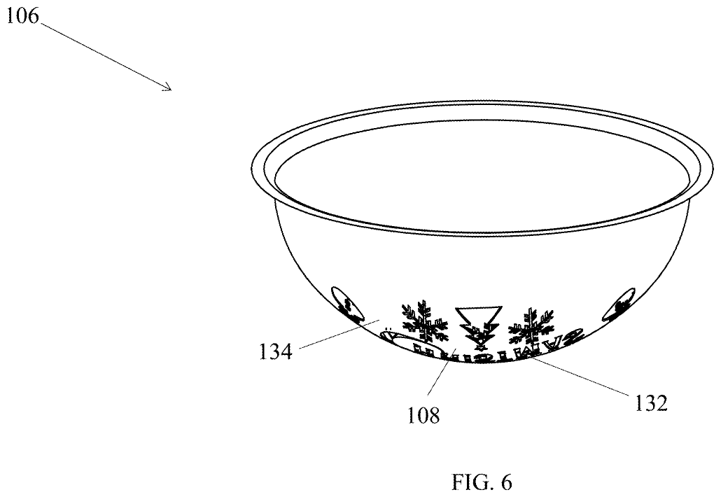

As shown in FIG. 6, the plurality of display films 106 are removable, replaceable, and molded to a shape complimentary to an inner surface 128 of the bottom cover 104. The display films 106 may also be molded to a shape complimentary to an outer surface 130 of the bottom cover 104. In some embodiments, the bottom cover 104 is a portion of a sphere (see FIGS. 2 and 4). The thickness of each of the plurality of display films 106 is less than 1.6 millimeters. Alternatively, the thickness of each of the plurality of display films 106 may be less than 1 millimeter, less than 0.75 millimeters, less than 0.5 millimeters, between 0.3 millimeters and 0.5 millimeters, or may be 0.4 millimeters. Particular embodiments of the display films 106 are formed of a transparent material. In a particular embodiment, the display films 106 are formed of polyvinyl chloride (PVC) through a thermoplastic molding process. Other transparent materials may also be used. For example, the display films 106 may be formed of polyethylene terephthalate (PET) or polystyrene (PS). The display films 106 are configured to be separately inserted into the bottom cover 104. Once inserted into the bottom cover 104, the selected display film 106 sits within the bottom cover 104. Each of the display films 106 has a different image 108. Each image 108 includes a subject 132 and a background 134. One of the subject 132 and the background 134 is transparent and the other one of the subject 132 and the background 134 is shaded. Thus, when light shines through the display film 106, the display film 106 filters the light so that the image 108 is projected onto a surface on the opposite side of the display film 106 from the light. When the floating light display 100 is floating in a pool and has a selected display film 106 sitting within the bottom cover 104, and the bottom light 116 is illuminated, the selected display film 106 seated within the bottom cover 104 filters the light emitted by the bottom light 116 to project the image 108 on an opposing surface within the pool or body of water. Thus, the user of the floating light display can select any image 108 from the plurality of display films 106 and project the selected image 108 onto a surface of the pool by inserting the display film 106 having the selected image 108 into the bottom cover 104, turning on the bottom light 116, and leaving the floating light display 100 to float in the pool.

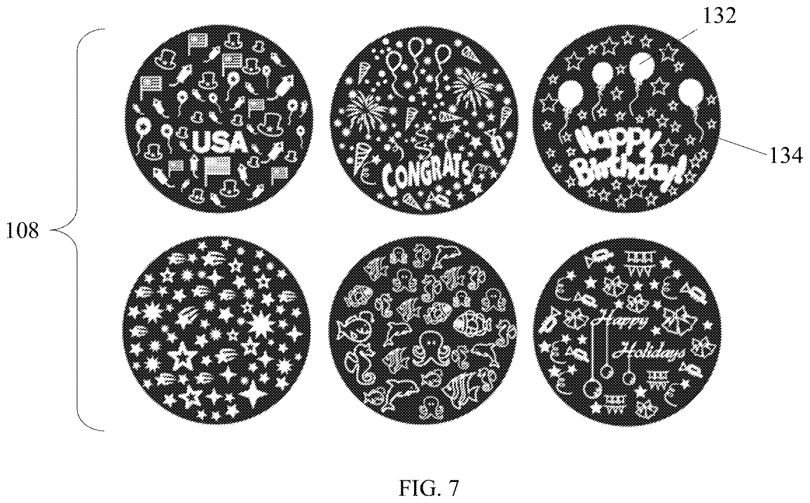

The image 108 can be any image that is desired. FIG. 7 illustrates six non-limiting examples of images 108 which may be displayed on a display film 106. The examples shown are displayed in two dimensions, but when implemented on a display film 106, the image wraps around the surface of the display film 106 is and three-dimensional. The image 108 may be printed on the inside surface or the outside surface of the display film 106. Alternatively, the image 108 may be located between an inner layer and an outer layer of the display film 106.

A method of use of the floating light display 100 in a swimming pool may comprise any of the following steps. A desired image 108 may be selected to display from the plurality of display films 106 included with the floating light display 100. The bottom cover 104 may be separated from the top cover 102. The selected display film 106 may be inserted into the bottom cover 104 or attached to the outside surface of the bottom cover 104. The top cover 102 may be attached to the bottom cover 104. The battery associated with the top cover 102 may be charged through solar power or other electrical power. The control button 120 on the top cover 102 or on the remote control operatively associated with the remote control sensor 122 may be pressed to select a lighting pattern display program stored within a processor associated with the top cover 102 to illuminate inside the bottom cover 104. The floating light display 100 may be placed into the pool so that the light within the bottom cover 104 shines against the inside of the display film 106 inside the bottom cover 104 and creates light and shadow patterns on a surface within the pool. The bottom cover 104 may be opened and the display film 106 may be changed for a different image 108. The light pattern may be changed for a different light pattern by pressing the control button 120 or using the remote control. The different image and light pattern may be displayed on the surface within the pool.

It will be understood that implementations of a floating light display are not limited to the specific assemblies, devices and components disclosed in this document, as virtually any assemblies, devices and components consistent with the intended operation of a floating light display may be used. Accordingly, for example, although particular floating light displays, and other assemblies, devices and components are disclosed, such may include any shape, size, style, type, model, version, class, measurement, concentration, material, weight, quantity, and/or the like consistent with the intended operation of floating light displays. Implementations are not limited to uses of any specific assemblies, devices and components; provided that the assemblies, devices and components selected are consistent with the intended operation of a floating light display.

Accordingly, the components defining any floating light display may be formed of any of many different types of materials or combinations thereof that can readily be formed into shaped objects provided that the materials selected are consistent with the intended operation of a floating light display. For example, the components may be formed of: polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; glasses (such as quartz glass), carbon-fiber, aramid-fiber, any combination thereof, and/or other like materials; composites and/or other like materials; metals, such as zinc, magnesium, titanium, copper, lead, iron, steel, carbon steel, alloy steel, tool steel, stainless steel, brass, nickel, tin, antimony, pure aluminum, 1100 aluminum, aluminum alloy, any combination thereof, and/or other like materials; alloys, such as aluminum alloy, titanium alloy, magnesium alloy, copper alloy, any combination thereof, and/or other like materials; any other suitable material; and/or any combination of the foregoing thereof. In instances where a part, component, feature, or element is governed by a standard, rule, code, or other requirement, the part may be made in accordance with, and to comply under such standard, rule, code, or other requirement.

Various floating light displays may be manufactured using conventional procedures as added to and improved upon through the procedures described here. Some components defining a floating light display may be manufactured simultaneously and integrally joined with one another, while other components may be purchased pre-manufactured or manufactured separately and then assembled with the integral components. Various implementations may be manufactured using conventional procedures as added to and improved upon through the procedures described here.

Accordingly, manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components.

It will be understood that methods for manufacturing or assembling floating light displays are not limited to the specific order of steps as disclosed in this document. Any steps or sequence of steps of the assembly of a floating light display indicated herein are given as examples of possible steps or sequence of steps and not as limitations, since various assembly processes and sequences of steps may be used to assemble floating light displays.

The implementations of a floating light display described are by way of example or explanation and not by way of limitation. Rather, any description relating to the foregoing is for the exemplary purposes of this disclosure, and implementations may also be used with similar results for a variety of other applications employing a floating light display.

What is claimed is:

1. A floating light display for a pool, the floating light display comprising:
a top cover having a top surface and a bottom surface opposite the top surface;
at least one top LED light visible at the top surface and at least one bottom LED light visible at the bottom surface;
a remote control sensor and at least one control button each disposed on the top surface and configured to control selection of at least one of a light illumination pattern and a light illumination color for the at least one top LED light and the at least one bottom LED light based on input from a user, wherein the remote control sensor is configured to receive the input from the user through a remote control;
a power charging port disposed on the top surface, covered by a water-resistant flap, and configured to charge the floating light display when electrically coupled to a power source;
a bottom cover formed of a transparent material and configured to couple with the top cover and enclose the at least one bottom LED light between the bottom cover and the top cover;
a seal configured to extend around a perimeter of the top cover and, when the bottom cover is coupled with the top cover, reduce fluid flow through an interface between the top cover and the bottom cover; and
a plurality of display films, including a selected display film, each having a thickness less than 1.6 millimeters and each molded to a shape complimentary to an inner surface of the bottom cover and configured to be separately inserted into and seated within the bottom cover, the display films each having a different image displayed on a respective display film, the image including a subject and a background, wherein one of the subject and the background is transparent and the other one of the subject and the background is shaded;
wherein, when the at least one bottom LED light is illuminated, the selected display film seated within the bottom cover filters the light emitted by the bottom light to project the image on an opposing surface within the pool.

2. The floating light display of claim 1, further comprising a solar panel disposed on the top surface and configured to charge the floating light display when the solar panel is exposed to the sun.

3. The floating light display of claim 1, wherein the plurality of display films each has a thickness of between 0.3 millimeters and 0.5 millimeters.

4. The floating light display of claim 1, wherein the at least one top LED light is an outer light ring.

5. A floating light display for a body of water, the floating light display comprising:
a top cover having a top surface and a bottom surface opposite the top surface;
at least one top light visible at the top surface and at least one bottom light visible at the bottom surface;
at least one control button disposed on the top surface and configured to control selection of at least one of a light illumination pattern and a light illumination color for the at least one top light and the at least one bottom light based on input from a user;
a charging port disposed on the top surface and configured to charge the floating light display when electrically coupled to a power source;
a bottom cover formed of a transparent material and configured to couple with the top cover and enclose the at least one bottom light between the bottom cover and the top cover; and
a plurality of display films, including a selected display film, each molded to a shape complimentary to an inner surface of the bottom cover and configured to sit within the bottom cover, the display films each having a different image displayed on a respective display film;
wherein, when the bottom light is illuminated, the selected display film seated within the bottom cover filters the light emitted by the bottom light to project the image on an opposing surface within the body of water.

6. The floating light display of claim 5, further comprising a remote control sensor disposed on the top surface and configured to control selection of at least one of the light illumination pattern and the light illumination color for the at least one top light and the at least one bottom light based on the input from the user, wherein the remote control sensor is configured to receive the input from the user through a remote control.

7. The floating light display of claim 5, the image including a subject and a background, wherein one of the subject and the background is transparent and the other one of the subject and the background is shaded.

8. The floating light display of claim 5, further comprising a seal configured to extend around a perimeter of the top cover and, when the bottom cover is coupled with the top cover, reduce fluid flow through an interface between the top cover and the bottom cover.

9. The floating light display of claim 5, further comprising a solar panel disposed on the top surface and configured to charge the floating light display when the solar panel is exposed to the sun.

10. The floating light display of claim 5, wherein the plurality of display films each has a thickness of between 0.3 millimeters and 0.5 millimeters.

11. The floating light display of claim 5, wherein the at least one top light is an outer light ring.

12. A floating light display for a body of water, comprising:
a top cover having a top surface and a bottom surface opposite the top surface;
at least one bottom light visible at the bottom surface;
a bottom cover formed of a transparent material and configured to couple with the top cover and enclose the at least one bottom light between the bottom cover and the top cover; and
a display film shaped complimentary to an inner surface of the bottom cover and configured to sit within the bottom cover;
wherein, when the bottom light is illuminated, the display film filters the light emitted by the bottom light to project an image on an opposing surface within the body of water.

13. The floating light display of claim 12, further comprising at least one top light disposed on the top cover.

14. The floating light display of claim 12, further comprising at least one control button disposed on the top surface and configured to control selection of at least one of a light illumination pattern and a light illumination color for the at least one bottom light based on input from a user.

15. The floating light display of claim 12, further comprising a remote control sensor disposed on the top surface and configured to control selection of at least one of a light illumination pattern and a light illumination color for the at least one bottom light based on input from a user, wherein the remote control sensor is configured to receive the input from the user through a remote control.

16. The floating light display of claim 12, further comprising a charging port disposed on the top surface and configured to charge the floating light when electrically coupled to a power source.

17. The floating light display of claim 12, further comprising a solar panel disposed on the top surface and configured to charge the floating light display when the solar panel is exposed to the sun.

18. The floating light display of claim 12, further comprising a seal configured to extend around a perimeter of the top cover and, when the bottom cover is coupled with the top cover, reduce fluid flow through an interface between the top cover and the bottom cover.

19. The floating light display of claim 12, wherein the display film has a thickness of less than 1.6 millimeters.

20. The floating light display of claim 12, wherein the display film has a thickness of between 0.3 millimeters and 0.5 millimeters.
